(19) United States
(12) Patent Application Publication
(10) Pub. No.: US 2026/0146500 A1
(43) Pub. Date: May 28, 2026

(54) SYSTEM, ASSEMBLY, AND METHOD FOR ROLLING A SHUTTER CURTAIN

(71) Applicant: Ori Kalman KATZ, Hatzor-Ashdod (IL)

(72) Inventor: Ori Kalman KATZ, Hatzor-Ashdod (IL)

(21) Appl. No.: 19/397,936

(22) Filed: Nov. 23, 2025

Related U.S. Application Data
(60) Provisional application No. 63/725,588, filed on Nov. 27, 2024.

(51) Int. Cl. E06B 9/34; E06B 9/40; E06B 9/44; E06B 9/50; E06B 9/72

(52) U.S. Cl. CPC E06B 9/34; E06B 9/44; E06B 9/50; E06B 9/72; E06B 2009/405

(57) ABSTRACT

A system and method to reduce a roller shutter box depth in a roller shutter system, the roller shutter system comprising a roller shutter box; a roller shutter curtain comprising a plurality of slats; and a plurality of shafts parallel each other, horizontally installed in the roller shutter box, located on an upper part of the roller shutter system and at least operational to hold the rolled shutter curtain; wherein at least one shaft is operational to rotate around its axis-of-rotation; and wherein adjacent shafts of the plurality of shafts are separated by a vertical gap, the method comprising: rolling the roller shutter curtain along a curved outline shell surface bounded by outer limits of the plurality of shafts and the rolled curtain. The rolling along the curved outline shell surface may be instrumental in reducing the roller shutter box depth.

### FIELD

The present disclosure relates generally to methods and systems for the design and installation of roller shutter systems and more particularly to methods and systems for reducing the shutter compartment or box depth in a roller shutter system.

### BACKGROUND

A roller shutter is a type of door or window (or any suitable opening) shutter curtain consisting of many horizontal slats (sometimes called bars or curtain profiles) hinged together. The door shutter is raised to open it and lowered to close it. On large doors or windows, the action may be motorized. It protects against sun, wind, rain, fire, theft, and noise and increases energy savings, enabling better climate control, privacy, and light control.

Roller shutter systems have been widely used for many decades as an efficient method for protecting doors and windows. At the beginning of the 20th century, roller shutters began proliferating in Europe. During the world wars, people in Europe needed a cheap way to protect their property from the plundering of soldiers and bandits, the weather, and the debris from the occasional bombing.

The early roller shutter systems used manual methods (e.g., belts or manual tapes) to open and close the shutter curtain. However, this was a relatively hard task for large shutters. In the last decades, the use of motors (a tubular motor fitted within the roller shaft tube) to roll the shutters was widely familiarized.

The main components of a roller shutter system are slats (including a bottom slat), a roller (i.e., shaft tube or axle), a shutter box, and guide rails.

The size of the shutter box compartment is a characteristic of the roller shutter system that may affect the way the roller shutter is installed above the opening (i.e., door or window). The shutter box may be designed to hold the roller shutter when it is open and the curtain is almost fully rolled on the roller. For tall shutters, the diameter of the rolled shutter may be significantly large and present installation challenges, including the width of the wall to hold the box, aesthetic issues, box protection, thermal insulation, etc. It can also limit the type of slats that can be used. In some cases, a certain depth of the roller shutter box may require a thicker wall, affecting the construction cost and the net living area.

During the last 30-40 years, many technological improvements have been introduced to improve the safety, security, quality, and reliability of roller shutter systems. Those include reliable motors to open and shut the shutters, improved guides, reliable sensors (e.g., proximity sensors, overheat sensors, etc.) to sense specific conditions of the shutter, molded slats to reduce friction and improve the shutter rolling, etc.

U.S. Pat. No. 8,857,497B1 discloses a Rolling Shutter System with a Plurality of Single Wall Slats that provides a method for a lightweight, easy-to-install rolling shutter assembly with single wall shutter slats that is flexible and is quickly installed in the field in the event of strong winds, such as during a storm or hurricane. World Intellectual Property Organization WO2008/004213 A2 discloses a Roller Shutter mechanism for installation in a building. The roller shutter mechanism includes a release mechanism which releases one or more components of the roller mechanism, and an access mechanism which provides sole internal access to the one component, by moving the one component.

### SUMMARY

As will be described, embodiments of the present disclosure relate to methods and systems for reducing the depth of the roller box in a roller shutter system.

The embodiments disclosed herein are only examples of the many possible advantageous uses and implementations of the innovative teachings presented herein. In general, statements made in the specification of the present disclosure do not necessarily limit any of the various embodiments. Moreover, some statements may apply to some inventive features but not to others. In general, unless otherwise indicated, singular elements may be in plural and vice versa with no loss of generality. In the drawings, numerals refer to like parts through several views.

The term “roller shutter” or “rolling shutter” and similar, as used herein, is intended to include but not be limited to any of the following: interior roller shutters, exterior roller shutters, manual roller shutters, electric roller shutters, built-in roller shutters, built-on roller shutters, PolyVinyl Chloride or aluminum roller shutters, and transparent roller shutters.

The term “slat”, “curtain profile”, and similar, as used herein, is intended to include but not be limited to any of the following: extruded or roll-formed steel, Poly Vinyl Chloride, aluminum, galvanized steel, or stainless steel, perforated or not perforated, single or multi-wall, and hollow or insulated designs.

The term “roller shutter curtain” and similar, as used herein, refers to a curtain composed of slats and is intended to include but not be limited to any of the following: a curtain with extruded or roll-formed steel slats, a curtain with Poly Vinyl Chloride, aluminum, galvanized steel or stainless-steel slats, perforated or not perforated, a curtain with single or multi-wall slats, and a curtain with hollow or insulated design slats.

The term “axis-of-rotation”, “rotation axis”, and similar, as used herein, refers to the central axis of a shaft. This is the straight line through all fixed points of the shaft's body, around which all other points of the shaft's body move in circles.

The term “roller box” and similar, as used herein refers to a box or compartment above the door or window, that holds the roller shutter and its shafts and is intended to include but not be limited to any of the following: built-in box, molded box, metal box, box made from self-extinguishing polystyrene foam, external box, thermally insulated box, external or internal box, reinforced and shielded box to increase security, and constructed box and roller boxes with internal or external cover.

The terms “shutter shaft” or “roller shutter shaft” and similar, as used herein are intended to include but not be limited to any of the following: metal roller, wood roller, synthetic material roller, roller manually activated (i.e., with a manual shaft), roller electrically activated (i.e., with a motorized shat), roller with sensors to prevent over rolling, roller with sensors to automatically deactivate the motor, rollers with different section shapes (e.g., circular, octagonal), roller with a gear, roller with bearings, rollers with an attachment to the shutter slats employing spring suspension, and rollers with a coiled spring operation in which the shutter slats are fixed directly to the shaft. The shutter shaft is sometimes referred to as the shutter axle.

The terms “shutter shaft” or “roller shutter shaft” and similar, as used herein, are intended to include a shaft with one or more hubs, wherein each hub comprises a sprocket wheel. The shaft-hub is inserted or threaded into the shaft and secured to it with screws or other methods.

The present disclosure here described provides a method that may reduce the depth of the roller shutter box or compartment in a roller shutter system, wherein the roller shutter system includes a roller shutter box; and a roller shutter curtain comprising a plurality of slats and, wherein the plurality of shafts are parallel to each other; and wherein the plurality of shafts is horizontally installed in the roller shutter box, wherein the roller shutter box is located on an upper part of the roller shutter system (i.e., above the opening) and at least operational to hold the roller shutter curtain when rolled around the plurality of shafts, wherein at least one shaft from the plurality is operational to rotate around its axis-of-rotation; and wherein adjacent shafts of the plurality of shafts are separated by a vertical gap, the method comprising; rolling the roller shutter curtain along a curved outline shell surface, the curved outline shell surface bounded by outer limits of the plurality of shafts and rolled roller curtain. In some embodiments, the rolling along the curved outline shell surface is instrumental in reducing the roller shutter box depth.

According to some embodiments, the roller shutter box may be a built-in box wherein the bottom side of this box is open to let the shutter curtain move up and down, and wherein the box front is also open and may be covered by a removable box front panel. According to some embodiments, the roller shutter box front with a removable box front panel may be used to install elements of the roller shutter system.

According to some embodiments, the rotation of a shaft of the plurality of parallel shafts causes the roller shutter curtain to roll along the curved outline shell surface. In some embodiments, the rotation of the top shaft causes the roller shutter curtain to roll along the curved outline shell surface. According to some embodiments, the curved outline shell surface may follow a contour, representing or bounded by the shape comprising the upper semicircle of the top shaft, including the rolled curtain, and the lower semicircle of the bottom shaft, including the rolled curtain.

According to some embodiments, the roller shutter system further comprises a coupling mechanism wherein a first shaft and a second shaft of the plurality of shafts are coupled by the coupling mechanism, and wherein rotation of the first shaft causes the second shaft to rotate in the same direction using the coupling mechanism.

According to some embodiments, the roller shutter system further comprises a coupling mechanism, wherein a first shaft and a second shaft of the plurality of shafts are coupled by the coupling mechanism, wherein the first shaft and second shaft have an axis-of-rotation, wherein the second shaft further comprises at least one element operational to rotate around the axis-of-rotation of the second shaft, and wherein rotation of the first shaft causes the at least one element in the second shaft to rotate in a same direction, using the coupling mechanism. According to some embodiments, the first shaft is the top shaft and the second shaft is the bottom shaft. According to some embodiments, the second shaft may comprise one or more sleeves that may rotate while the second shaft itself does not rotate.

According to some embodiments, the coupling mechanism may comprise at least one of a chain, a belt (including a belt conveyor), a gear, and a cable, wherein the roller shutter curtain is attached to the coupling mechanism, and wherein rotation of the first shaft causes the roller shutter curtain to roll along the curved outline shell surface. According to some embodiments, the coupling mechanism may be implemented using a synchronized motor on each of the shafts or, any other mechanism that allows synchronized rotation of the shafts. According to some embodiments, the coupling mechanism (i.e., chain, belt, etc.) may be located on the extremes of the shaft or at any part along the shaft.

According to some embodiments, the cross-section of the shafts may be of different shapes. According to some embodiments, the cross-section may be circular or octagonal, as may be selected in some types of roller shutter systems.

According to some embodiments, a shaft may comprise a shaft body into which one or more shaft-hubs may be inserted or threaded. A shaft-hub may comprise a coupling mechanism (i.e., chain, belt, etc.). According to some embodiments, using a shaft-hub may facilitate the installation of the roller shutter system, allowing the positioning of the coupling mechanism to be defined during the installation phase.

According to some embodiments, the cross-section of the shaft-hub is matched to the cross-section of the shaft (e.g., circular, octagonal, etc.). According to some embodiments, the shaft-hub may be secured to the shaft with screws or other methods.

According to some embodiments, the roller shutter curtain may be rolled manually, for example, by using a manual belt that enables the top shaft to rotate in a desired direction. According to some embodiments, manual rolling may also comprise the use of a spring that reduces the force required to lift (raise) the shutter curtain. According to some embodiments, the manual rolling mechanism does not comprise a spring.

According to some embodiments, the method may further comprise the use of a coupling mechanism that may comprise multiple chains, belts, or the like. As may be apparent to the skilled in the art, a larger number of chains, belts, or the like may better divide the load between them (e.g., for a large roller shutter curtain) and may also prevent the bending of slats lying on the shaft.

According to some embodiments, the method may also comprise attaching the shutter curtain to the coupling mechanism. Further, according to some embodiments, the first or upper slat of the curtain may be attached to the coupling mechanism (e.g., belt, chain), and when the belt or chain moves around the shafts, the shutter curtain moves with it. Many methods may be used to attach the curtain to the coupling mechanism, including the use of connection pins, cords, twines, strings, cables, springs, etc. According to some embodiments, the attachment of the first slat to a chain is performed with a pin that is also a part of the chain.

According to some embodiments, the method may also comprise a chain or belt tension mechanism that may keep the chain or belt tight. For example, according to some embodiments, the top shaft of the roller shutter system may be fixed while the bottom shaft may move up and down. According to some embodiments, the tension mechanism may comprise a spring that pulls the bottom shaft down and maintains the chain or belt tight. According to some embodiments, the tension mechanism may comprise brackets on the bearing panels holding the shaft and chain, and a tension screw.

In some embodiments, when more than two chains or belts are used, it may be necessary to keep the required tension of a chain or belt (e.g., a chain or belt in the center of the shaft) by using a floating chain-tension device. According to some embodiments, the floating chain-tension device may comprise two plates and bearings, wherein the plates are adjusted to keep the required chain tension. According to some embodiments, the floating chain-tension device is located between the shafts on both sides of a chain or belt.

According to some embodiments, one or more floating chain-tension devices may be necessary to keep the required tension of the chains or belts, in accordance with the number of chains or belts, the length of the shafts, the height of the roller shutter curtain, etc.

According to some embodiments, the vertical gap between the shafts is variable (i.e., the size of the vertical gap may be increased or decreased), and wherein the vertical gap size is selected, at least, in accordance with a depth of the roller shutter box. As may be apparent to the skilled in the art, the vertical gap between the shafts affects the total number of turns rolled on the shafts when the shutter curtain is fully open (i.e., fully rolled). A larger vertical gap between the shafts will reduce the number of turns and, consequently, may reduce the required depth of the roller shutter box.

According to some embodiments, the vertical gap between the shafts is variable (i.e., the size of the vertical gap may be increased or decreased), and wherein the length of the vertical gap is in accordance with an alignment of at least a first turn of the roller shutter curtain with a contour of the plurality of shafts (i.e., the first turn of the roller curtain to be well adhered to the shafts). According to some embodiments, the shape and height of the roller shutter curtain slats may influence the vertical gap sizes to be selected.

According to some embodiments, during the roller shutter installation, the vertical gap between the shafts may be dynamically modified and adapted to the wall thickness.

According to some embodiments, at least one shaft further comprises bearings, and wherein the coupling mechanism in the at least one shaft is attached to the bearings. In some embodiments, the shaft is the bottom shaft.

According to some embodiments, at least one shaft further comprises at least one sleeve inserted on the at least one shaft, wherein the sleeve prevents bending of the slats lying on the at least one shaft. According to some embodiments, the at least one sleeve has a thickness in accordance with the coupling mechanism (e.g., chain), thus allowing the slats to lie stiff on the shaft. In some embodiments, the at least one shaft is the top shaft.

According to some embodiments, each of the shafts may comprise one or more sleeves that may prevent contact between the slats and the coupling mechanism (e.g., chain). According to some embodiments, the thickness of the sleeves is in accordance with the coupling mechanism, thus allowing the slats to lie stiff on the sleeves (e.g., of the top shaft) and, in addition, prevent any contact of the slat surface with the coupling mechanism (e.g., chain) in any of the shafts. As may be apparent to the skilled in the art, those sleeves may prevent chain links from scratching or damaging the surface or the paint of the first turn of slats. According to some embodiments, the sleeves may ensure a gap of 1-2 mm between the slats and the coupling mechanism. According to some embodiments, the sleeves may be made, but not be limited to any of the following: metal, wood, and synthetic material, and comprise a coating to protect the curtain slats against scratches or damage.

According to some embodiments, the roller shutter system further comprises an electrical motor, and wherein the rotation of at least one shaft is driven by the electrical motor. According to some embodiments, the motor drives the rotation of the top shaft. In some embodiments, rotation of the top shaft drives the rolling of the roller shutter curtain.

According to some embodiments, the vertical gap between the shafts may be selected to yield complete turns of the roller shutter curtain when the shutter curtain is fully or almost fully rolled around the plurality of shafts. A complete turn of the roller shutter curtain occurs when a slat of the roller curtain overlaps with the first slat of the curtain attached to the coupling mechanism.

As may be apparent to the skilled in the art, when the shutter curtain is rolled, the number of curtain layers rolled on the shafts may be smaller than the number of curtain layers rolled on a shaft in a roller shutter system with a single shaft. This smaller number of layers may also be instrumental to a reduced deterioration of the curtain and/or slats.

The present embodiments here described provide a roller shutter system, comprising: a) a roller shutter box and, b) a roller shutter curtain comprising a plurality of slats and, c) a plurality of shafts, parallel each other, wherein the plurality of shafts is horizontally installed in the roller shutter box, wherein the roller shutter box is located on an upper part of the roller shutter system, and at least used to hold the rolled shutter curtain; wherein at least one shaft from the plurality is operational to rotate around its axis-of-rotation and, wherein adjacent shafts of the plurality of shafts are separated by a vertical gap; and wherein the roller shutter curtain is rolled along a curved outline shell surface, the curved outline shell surface bounded by outer limits of the plurality of shafts and rolled curtain. In some embodiments, the rolling along the curved outline shell surface is instrumental in reducing roller shutter box depth.

According to some embodiments, the roller shutter curtain slats or curtain profiles may be of many types, including any of the following: extruded or roll-formed steel, PolyVinyl Chloride, aluminum, galvanized steel, or stainless steel, perforated or not perforated, single or multi-wall, and hollow or insulated designs. As may be apparent to the skilled in the art, any type of slats and/or roller shutter curtains may be applicable.

According to some embodiments, the rotation of at least one shaft of a plurality of parallel shafts causes the roller shutter curtain to roll along the curved outline shell surface.

According to some embodiments, the roller shutter system further comprises a coupling mechanism wherein a first shaft and a second shaft of the plurality of shafts are coupled by the coupling mechanism, and wherein the rotation of the first shaft causes the second shaft to rotate in same direction using the coupling mechanism.

According to some embodiments, the roller shutter system further comprises a coupling mechanism, wherein a first shaft and a second shaft of the plurality of shafts are coupled by the coupling mechanism, wherein the first shaft and second shaft have an axis-of-rotation, wherein the second shaft further comprises at least one element operational to rotate around the axis-of-rotation of the second shaft, and wherein the rotation of the first shaft causes the at least one element in the second shaft to rotate in a same direction, using the coupling mechanism.

According to some embodiments, the coupling mechanism comprises at least one of a chain, a belt, a gear, and a cable, wherein the roller shutter curtain is attached to the coupling mechanism, and wherein the rotation of the first shaft causes the roller shutter curtain to roll along the curved outline shell surface.

According to some embodiments, the at least one shaft comprises bearings, and wherein the coupling mechanism in the at least one shaft is attached to the bearings.

According to some embodiments, the roller shutter system further comprises an electrical motor, wherein the rotation of the least one shaft is driven by the electrical motor. According to some embodiments, the motor drives the rotation of the top shaft.

The present disclosure here described provides a roller shutter assembly installed in a roller shutter box or compartment, wherein the roller shutter box is located on an upper part of a roller shutter system, the roller shutter assembly at least comprising a plurality of shafts, parallel each other, wherein the plurality of shafts is horizontally installed in the roller shutter box, wherein at least one shaft from the plurality is operational to rotate around its axis-of-rotation and, wherein adjacent shafts of the plurality of shafts are separated by a vertical gap; and wherein the roller shutter box is operational to hold a roller shutter curtain rolled along a curved outline shell surface, the curved outline shell surface bounded by outer limits of the plurality of shafts and rolled curtain. In some embodiments, rolling the roller shutter curtain along the curved outline shell surface is instrumental in reducing roller shutter box depth.

The term assembly, as used herein, may refer to a collection of parts of a roller shutter apparatus. In some embodiments, the collection need not include all the parts necessary for a complete roller shutter apparatus. In some embodiments, one or more parts not specifically listed, for example a motor and/or an electrical connection, may not be included in the assembly. In some embodiments, the assembly may be a kit.

According to some embodiments, the roller shutter compartment may be a built-in box wherein the bottom side of this box is open to let the shutter curtain move up and down, and wherein the box front is also open and may be covered by a removable box front panel. According to some embodiments, the front side of the roller shutter box may comprise a removable cover that may be used to install elements of the roller shutter assembly. According to some embodiments, the roller shutter box may be located above the opening, inserted into the wall, externally mounted, or a combination of both (e.g., when the depth of the roller shutter box is larger than the available space in the wall). According to some embodiments, the roller shutter box may be of many types, including a built-in box, molded box, metal box, box made from a self-extinguishing polystyrene foam, external box, thermally insulated box, internal box, reinforced and shielded box to increase security, and roller shutter boxes with internal or external cover.

According to some embodiments, the rotation of at least one shaft causes a shutter curtain attached to the roller shutter assembly to roll along the curved outline shell surface.

According to some embodiments, the roller shutter assembly further comprises a coupling mechanism, and wherein a first and a second shaft of the plurality of shafts are coupled by the coupling mechanism, wherein the rotation of the first shaft causes the second shaft to rotate in same direction using the coupling mechanism.

According to some embodiments, the roller shutter assembly further comprises a coupling mechanism, and wherein a first shaft and a second shaft of the plurality of parallel shafts are coupled by the coupling mechanism, wherein the first shaft and second shaft have an axis-of-rotation, wherein the second shaft further comprises at least one element operational to rotate around the axis-of-rotation of the second shaft, and wherein the rotation of the first shaft causes the at least one element in the second shaft to rotate in a same direction, using the coupling mechanism.

According to some embodiments, the coupling mechanism comprises at least one of a chain, a belt, a gear, and a cable, and wherein the rotation of the first shaft causes a roller shutter curtain attached to the coupling mechanism to roll along the curved outline shell surface.

According to some embodiments, at least one shaft comprises at least one sleeve inserted on the shaft, wherein the sleeve prevents bending of the slats lying on the shaft. According to some embodiments, the top shaft comprises at least one sleeve inserted on the shaft. According to some embodiments, the roller shutter curtain comprises a plurality of slats, wherein a first shaft of the plurality of shafts is a top shaft and a second shaft of the plurality of shafts is a bottom shaft, wherein at least the top shaft further comprises at least one sleeve inserted on the top shaft, wherein the sleeve prevents bending of the slats lying on the top shaft.

According to some embodiments, the roller shutter curtain comprises a plurality of slats, wherein each of the shafts may comprise one or more sleeves to prevent contact between the slats and the coupling mechanism (e.g., chain). According to some embodiments, the thickness of the sleeves is in accordance with the coupling mechanism, thus allowing the slats to lie stiff on the sleeves (e.g., of the top shaft) and, in addition, prevent any contact of the slat surface with the coupling mechanism (e.g., chain) in any of the shafts. As may be apparent to the skilled in the art, those sleeves may prevent chain links from scratching the surface of the first turn of slats. According to some embodiments, the sleeves may ensure a gap of 1-2 mm between the slats and the coupling mechanism.

According to some embodiments, the roller shutter assembly further comprises an electrical motor wherein the rotation of the least one shaft is driven by an electrical motor. According to some embodiments, the motor drives the rotation of the top shaft.

According to some embodiments, the assembly comprises two shafts. According to some embodiments, large and heavy roller shutter curtains may comprise more than two shafts that may distribute the weight of the curtain on more than two shafts.

One skilled in the art will realize the disclosed embodiments may be embodied in other specific forms without departing from the spirit or essential characteristics thereof. The foregoing embodiments are therefore to be considered in all respects illustrative rather than limiting of the embodiments described herein. In the foregoing detailed description, numerous specific details are outlined in order to provide an understanding of the embodiments. However, it will be understood by those skilled in the art that embodiments can be practiced without these specific details. In other instances, well-known methods, procedures, components, modules, units, and/or circuits have not been described in detail so as not to obscure the embodiments. Some features or elements described with respect to some embodiments can be combined with features or elements described with respect to other embodiments. The embodiments referred to above, and other embodiments, are described in detail in the next section.

### BRIEF DESCRIPTION OF THE DRAWINGS

Various embodiments are particularly pointed out and distinctly claimed in the claims after the specification. The foregoing and other objects, features, and advantages will be apparent from the following detailed description taken in conjunction with the accompanying drawings.

FIG. 1: Shows a cross-section of an exemplary embodiment of the roller shutter suitable for the implementation of an exemplary embodiment.

FIG. 2a: Shows a schematic diagram of a roller shutter system with one shaft, the diagram used to support the calculation of the roller box size.

FIG. 2b: Shows a schematic diagram of a roller shutter system with two shafts, the diagram used to support the calculation of the roller box size in accordance with exemplary embodiments.

FIG. 3a, FIG. 3b, and FIG. 3c are graphs illustrating different aspects of the roller shutter box depth reduction in accordance with exemplary embodiments.

FIG. 4a: Shows an exploded view of a left side panel assembly wherein the left side panel comprises the height-alignment of two shafts in accordance with exemplary embodiments.

FIG. 4b: Shows the assembled left side panel of FIG. 4a.

FIG. 5a: Shows an exploded view of a right-side panel assembly wherein the right-side panel comprises height alignment of the bottom shaft only, in accordance with exemplary embodiments.

FIG. 5b: Shows the assembled right-side panel of FIG. 5a.

FIG. 6a: Shows two sprocket wheels with the coupling mechanism mounted on a shaft-hub in accordance with an exemplary embodiment.

FIG. 6b: Shows an exploded view of a floating chain-tension device in accordance with an exemplary embodiment.

FIG. 6c: Shows a floating chain-tension device located between two sprocket wheels with the coupling mechanism in accordance with an exemplary embodiment.

FIG. 7: Shows an exploded view of the top shaft body of a roller shutter system in accordance with an exemplary embodiment.

FIG. 8: Shows an exploded view of a single slat of a roller shutter curtain in accordance with an exemplary embodiment.

FIG. 9: Shows an exploded view of the roller shutter box of a roller shutter system in accordance with an exemplary embodiment.

FIG. 10a: Shows a roller shutter system, wherein the roller shutter curtain is almost fully rolled around the shafts in accordance with an exemplary embodiment.

FIG. 10b: Shows a roller shutter system, wherein the roller shutter curtain is not rolled around the shafts in accordance with an exemplary embodiment.

FIG. 10c: Shows a roller shutter system, wherein the roller shutter curtain is not rolled around the shafts and wherein the shafts further comprise sleeves in accordance with an exemplary embodiment.

FIG. 10d: Shows a roller shutter system, wherein a floating chain-tension device is located between the shafts and around the center chain in accordance with an exemplary embodiment.

### DETAILED DESCRIPTION

The terminology used herein is to describe particular embodiments only and is not intended to be limiting. As used herein, the term “and/or” includes any and all combinations of one or more of the associated listed items. As used herein, the singular forms “a,” “an,” and “the” are intended to include the plural forms as well as the singular forms, unless the context indicates otherwise.

It will be further understood that the terms “comprises” and/or “comprising” and/or “includes” and/or “including” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In the described embodiments, it will be understood that several techniques and elements are disclosed. Each of these has individual benefit and each can also be used in conjunction with one or more, or in some cases all, of the other disclosed techniques. Accordingly, for the sake of clarity, this description may refrain from repeating every possible combination of the individual steps in an unnecessary fashion.

Nevertheless, the specification and claims should be read with the understanding that such combinations may be entirely within the scope of the invention.

In the following description, for purposes of explanation, numerous specific details are outlined in order to provide a thorough understanding of the present disclosure. It will be evident, however, to one skilled in the art that disclosed embodiments may be practiced without these specific details.

The present disclosure is to be considered as an exemplification of the invention and is not intended to limit the invention to the specific embodiments illustrated by the figures or description below.

Reference will now be made in detail to the present embodiments of the disclosure, certain examples of which are illustrated in the accompanying drawings.

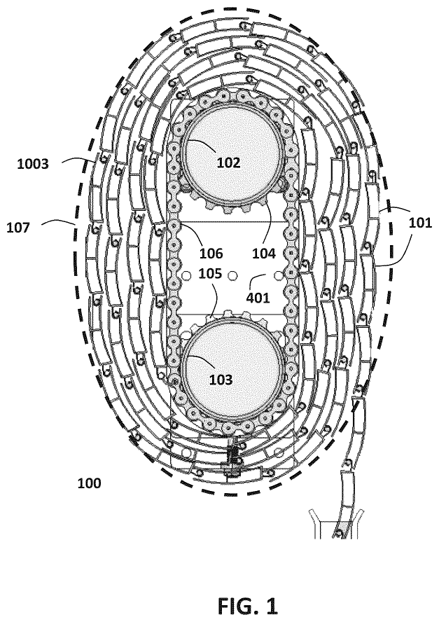

FIG. 1 shows a cross-section 100 of a roller-shutter system that illustrates the operation principles of the roller shutter system in accordance with disclosed embodiments. The components and elements that are illustrated in FIG. 1 may vary with the disclosed embodiments.

FIG. 1 also shows a curtain 1003 of a roller shutter comprising a plurality of slats or curtain profiles 101, rolled around the top shaft 102 and the bottom shaft 103. The top shaft 102 and the bottom shaft 103 are horizontally mounted, one above the other and parallel to each other. There is a vertical gap between the top shaft 102 and the bottom shaft 103.

According to some embodiments, the top shaft 102 and the bottom shaft 103 are coupled by a coupling mechanism, and the rotation of one shaft causes the other shaft to rotate in the same direction using the coupling mechanism. According to some embodiments, a sprocket wheel 104 is fixedly attached to the top shaft 102, and a sprocket wheel 105 is fixedly attached to the bottom shaft 103. According to some embodiments, a chain 106 geared on the sprocket wheels 104, 105 links between the top shaft 102 and bottom shaft 103. According to some embodiments, a left side panel plate 401 holds or mounts the top shaft 102 and the bottom shaft 103 on the left side. In some embodiments, the top shaft 102 and the bottom shaft 103 have an axis-of-rotation, wherein the bottom shaft further comprises at least one element operational to rotate around the axis-of-rotation of the second shaft, and wherein rotation of the first shaft causes the at least one element in the second shaft to rotate in a same direction, using the coupling mechanism. The coupling mechanism may comprise at least one of a chain, a belt, a gear, or a cable.

The terms “left” and “right” are used merely for descriptive convenience, as viewed from a particular vantage point in the accompanying figures. In practice, the two sides may be mirror image equivalents, and no particular orientation is required.

With further reference to FIG. 1, the curtain 1003 of a roller shutter may roll along a curved outline shell surface 107 (represented by a dotted line) bounded by the outer limits of the top shaft 102, the bottom shaft 103, and the rolled curtain. Each additional turn of the rolled curtain expands the outer limits. The length of the rolled curtain 1003 in each turn increases for each new turn. According to some embodiments, the first slat (the upper slat) of the curtain 1003 is attached to a chain 106 in a way that when the top shaft 102 rotates in a certain direction, also the bottom shaft 103 rotates in the same direction and the curtain 1003 attached to the chain 106 is rolled up along the curved outline shell surface 107 or unrolled depending on the shaft's rotation direction. In some embodiments, top shaft 102 is centered over bottom shaft 103.

In some embodiments, a shaft may comprise a shaft body into which one or more shaft-hubs may be inserted. A shaft-hub may comprise a coupling mechanism (i.e., chain, belt, etc.).

In some embodiments, the roller shutter may comprise at least two chains on both sides of the shaft. This allows the division of the load on two chains and better attachment of the curtain. In other embodiments, the roller shutter may comprise three or more chains, depending on the length of the shaft.

As may be seen in FIG. 1, each complete turn of the rolled curtain 1003 comprises the upper half of the top shaft 102, two times the distance between the centers of the top shaft 102 and the bottom shaft 103, and the bottom half of the bottom shaft 103.

One skilled in the art will appreciate that in the embodiment described in FIG. 1, the total number of turns of the curtain 1003 when rolled on the top shaft 102 and the bottom shaft 103 is smaller than the number of turns of the same curtain when rolled on a single shaft.

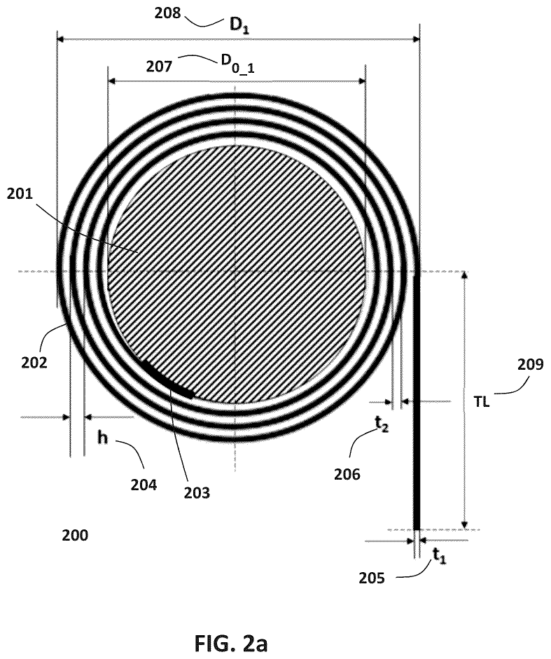

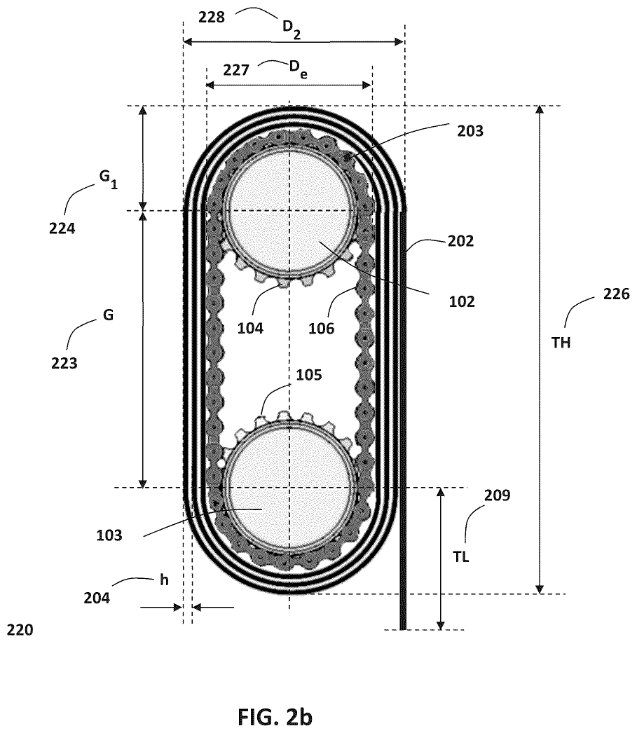

FIG. 2a shows a schematic diagram 200 of a prior art roller shutter system comprising a single shaft. For clarity purposes, the diagram in FIG. 2a may not be to scale and shows the cross-section of a circular shaft with a rolled curtain on it. The purpose is to calculate the size of the required roller shutter box in accordance with the different parameters of the roller shutter system.

Referring now to FIG. 2a, a roller shutter system comprising a shaft 201 with a shaft diameter D₀₋₁ 207 and a simplified curtain 202 rolled around the shaft 201, is depicted. According to some embodiments, the simplified curtain 202 is attached to the shaft 201 by an attachment 203.

For clarity purposes and simplicity of the calculations, the simplified curtain 202 is depicted as a continuous surface without slats, while in practice, the shutter curtain may comprise slats and other elements not shown.

According to some embodiments, the simplified curtain 202 has a width of t₁ 205 (i.e., slat's thickness) and there is an air gap of t₂ 206 between two adjacent layers of the rolled simplified curtain 202. For simplicity, it is assumed that the total gap between two adjacent layers (i.e., t₁+t₂) is uniform for all the curtain layers. As may be apparent to the skilled in the art, many types of slats are commercially available, each with a specific thickness and construction.

Let D₁ be the outer diameter of the rolled simplified curtain 202, h 204 be the total gap between any two adjacent layers of the rolled simplified curtain 202 (i.e., h=t₁+t₂), and let L denote the length of the simplified curtain 202 rolled on the shaft 201. According to some embodiments, when the shutter curtain is fully rolled on the shaft 201, a tail 209 of the curtain is not rolled. Let N be the number of turns of the rolled curtain.

According to some embodiments, when the simplified curtain 202 is rolled on the shaft 201, the outer diameter D₁ 208 of the shaft 201 (including the rolled simplified curtain 202) increases, as the length L of the rolled curtain increases.

For a 1-shaft roller shutter, the number of turns N is calculated by:

$$N = \frac{{D}_{1} - {D}_{{0}_{1}}}{2 h} \qquad Eq . 1$$

$$or$$

$${D}_{1} = 2 hN + {D}_{{0}_{1}} \qquad Eq . 2$$

Where:
D_{0_1}: Shaft diameter 207 (shaft 201)
D₁: Outer shaft diameter 208 (shaft 201), including the simplified curtain 202 already rolled
h: Total gap, comprises the thickness 205 of the simplified curtain 202 and the air gap 206 between the layers.
N: Number of turns of the simplified curtain 202 rolled on the shaft 201.

The number of turns N, can be calculated as follows:

$${N}^{2} h + N [ {D}_{{0}_{1}} - h ] - \frac{L}{π} = 0 \qquad Eq . 3$$

Since only the positive root is physically feasible

$$N = \frac{- ( {D}_{{0}_{1}} - h ) + \sqrt{{( {D}_{{0}_{1}} - h )}^{2} - \frac{4 L h}{π}}}{2 h} \qquad Eq . 4$$

Once the number of turns N is calculated, the outer diameter D₁ 208 can also be calculated (using the equation Eq. 2). As may be apparent to the skilled in the art, and according to some embodiments, the internal depth of a roller shutter box comprising the shaft 201 and the rolled simplified curtain 202, shall be at least D₁ 208 to let the roller shutter rotate inside the roller box.

Referring now to FIG. 2b, a schematic cross-section of a roller shutter system 220 suitable for the implementation of an exemplary embodiment is depicted. FIG. 2b shows a simplified diagram that may not be to scale and shows the cross-section of two shafts 102-103 with a rolled simplified curtain 202 on them, including a few additional elements. As may be apparent to the skilled in the art, the components and elements that are illustrated in FIG. 2b may vary among different embodiments.

According to some embodiments, a roller shutter system 220 comprising two shafts, a top shaft 102 and a bottom shaft 103, both with a shaft diameter D_{0_1} 207 and a simplified curtain 202 rolled around the top shaft 102 and the bottom shaft 103, is depicted. According to some embodiments, the simplified curtain 202 is attached to the top shaft 102 with an attachment 203. For clarity purposes, the simplified curtain 202 is depicted as a continuous surface without slats, while in practice, the roller shutter curtain may comprise slats and other elements not shown.

According to some embodiments, the top shaft 102 comprises a sprocket wheel 104 and the bottom shaft 103 comprises a sprocket wheel 105. A chain 106 geared on the sprocket wheels 104, 105 links between the upper and bottom shafts. According to some embodiments, the rotation of one shaft causes the other shaft to rotate in the same direction.

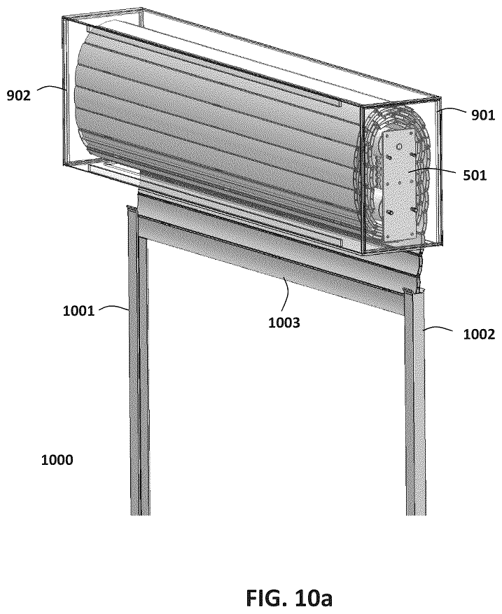

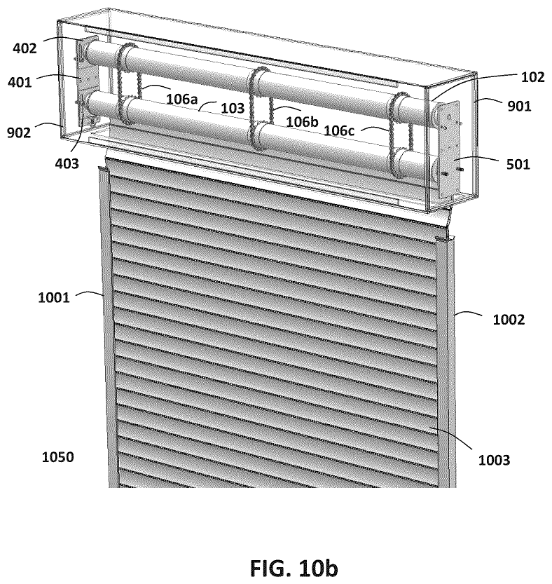

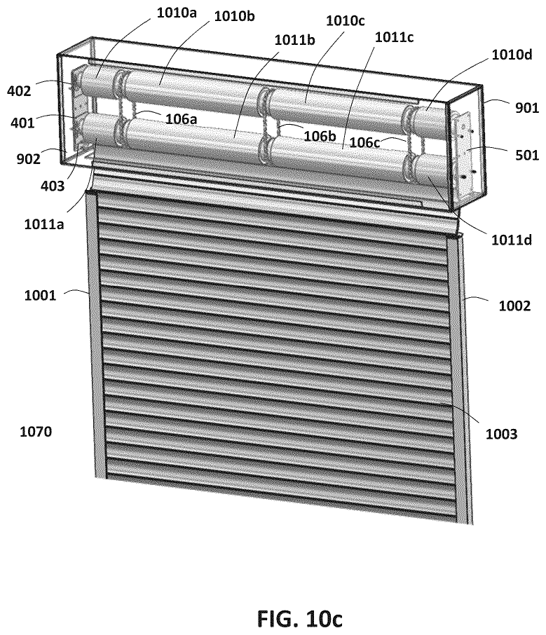

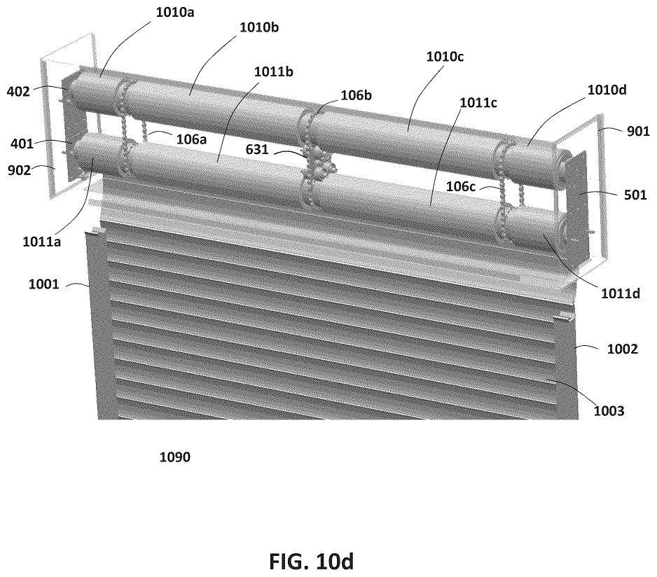

According to some embodiments, the simplified curtain 202 is rolled above the chain 106, and not directly touching the shaft surface, as shown in FIG. 2b. Therefore, when calculating the number of turns of the rolled curtain, the effective diameter Dₑ 227 of the top shaft 102 and the bottom shaft 103 shall be used. This effective diameter Dₑ 227 is larger than D_{0_1} of a 1-shaft roller shutter that does not comprise a chain. In some embodiments, the simplified curtain 202 is rolled on sleeves 1010a, 1010b, 1010c, 1010d, 1011a, 1011b, 1011c and 1011d (FIG. 10 hereinbelow) and not directly touching the shaft surface or the chain links. For the sake of simplicity, the effective diameter Dₑ 227 will be used for the analysis.

As in FIG. 2a, it is assumed that the total gap between two adjacent layers is uniform for all the curtain layers.

Let D₂ be the outer diameter 228 of the rolled simplified curtain 202, h 204 be the total gap between any two adjacent layers of the rolled simplified curtain 202, and let denote L, the length of the simplified curtain 202 rolled on the top shaft 102 and bottom shaft 103. According to some embodiments, when the simplified curtain 202 is fully rolled on the top shaft 102 and the bottom shaft 103, a tail 209 of the curtain is not rolled.

According to some embodiments, when the simplified curtain 202 is rolled on the top shaft 102 and the bottom shaft 103, the outer diameter D₂ 228 of the shaft 201, including the rolled simplified curtain 202, increases as the length L of the rolled curtain increases.

The outer diameter D₂ 228 of the top shaft 102 or bottom shaft 103 with the simplified curtain 202 already rolled, as a function of the rolled shutter curtain length L, is calculated in the following paragraphs. As may be apparent to the skilled in the art, and according to some embodiments, the internal depth of a roller shutter box comprising the top shaft 102 and the bottom shaft 103 and the rolled simplified curtain 202 shall be at least the size of the outer diameter D₂ 228 to let the roller shutter rotate inside the roller box.

Referring to FIG. 2b, the length L of the shutter rolled on the top shaft 102 and the bottom shaft 103 may approximately be expressed as:

$$L = ( π {D}_{e} + 2 G ) + [ π ( {D}_{e} + 2 h ) + 2 G ] + … + [ π ( {D}_{e} + ( N - 1 ) h ) + 2 G ] \qquad Eq . 5$$

Where:
Dₑ: The effective diameter 227 of the top shaft 102 and the bottom shaft 103 (including the chain 106 or sleeves 1010a, 1010b, 1010c, 1010d, 1011a, 1011b, 1011c and 1011d).
h: Total gap comprises the thickness of the simplified curtain 202 and the air gap between the layers
N: Number of turns of the simplified curtain 202 rolled on the top shaft 102 and bottom shaft 103.
G: Vertical gap 223 between the axis-of-rotation of the top shaft 102 and the bottom shaft 103. This distance shall be greater than the effective diameter Dₑ 227 of the shafts:

$$G > {D}_{e} \qquad Eq . 6$$

As can be seen, for each turn, a length of 2G is added to the rolled curtain length. Then:

$$L = π N [ {D}_{e} + h ( N - 1 ) ] + 2 GN \qquad Eq . 7$$

$${N}^{2} h + N [ {D}_{e} + \frac{2 G}{π} - h ] - \frac{L}{π} = 0 \qquad Eq . 8$$

Since only the positive root is physically feasible, the number of turns may be calculated as follows:

$$N = \frac{- ( {D}_{e} + \frac{2 G}{π} - h ) + \sqrt{{( {D}_{e} + \frac{2 G}{π} - h )}^{2} - \frac{4 Lh}{π}}}{2 h} \qquad Eq . 9$$

Then, the outer diameter D₂ 228 of the top shaft 102 and bottom shaft 103 with N turns rolled, may be calculated:

$${D}_{2} = 2 Nh + {D}_{e} \qquad Eq . 10$$

In addition, according to some embodiments, one can calculate G₁, which is the top gap 224 that may affect the distance from the center of the top shaft 102 to the upper wall of the roller shutter box. Then, the total height TH 226 of the roller shutter assembly, which may affect the vertical dimension of the roller shutter box to hold the roller shutter system with two shafts, can be calculated as follows:

$${G}_{1} = N h + \frac{{D}_{e}}{2} \qquad Eq . 11$$

$$and$$

$$TH = {D}_{2} + G \qquad Eq . 12$$

Table 1 compares the number of turns N and the diameter of a fully rolled shaft between a roller shutter system with one shaft and a roller shutter system with two shafts.

The values in the table are calculated using the equations previously described and with the following assumptions:
D_{0_1}: 6.00 cm.
Dₑ: 8.50 cm (this includes an additional 2.5 cm due to the sprocket wheel)
h: 0.75 cm (7 mm slat thickness and 0.5 mm air gap between the slat layers)

As may be apparent to the skilled in the art, typical roller shutter curtains have a length difference when the curtain is open (i.e., rolled on a shaft) and when the curtain is closed on the opening (i.e., no rolled curtain on the shaft). This is due to the construction of the slats that allow light penetration when two adjacent slats are separated. Therefore, a rolled curtain, when all the slats are fully separated, is longer than a closed curtain when all the slats are fully compressed against each other. The difference between those two lengths depends on the slat type. For example, this difference will be larger with a curtain with light slats, which have large holes for light penetration. In Table 1, the first two columns denote the length of the curtain when fully closed on the opening (e.g., door or window) and when fully rolled on a shaft. For the calculations in Table 1, it is assumed that the slat height is 5.5 cm when fully closed and 7.5 cm when open.

TABLE 1
Roller shutter system with one shaft versus a roller shutter system with two shafts

| 1 | 2 | | | | 6 | 7 | 8 | 9 | 10 | 11 | 12 | 13 | 14 | 15 | 16 | 17 |
|---|---|---|---|---|---|---|---|---|---|---|---|---|---|---|---|---|
| Curtain length - | | 3 | 4 | 5 | 2-shaft, | | | 2-shaft, | | | 2-shaft, | | | 2-shaft, | | |
| [cm] | | 1-Shaft | | | G = 20 cm | | | G = 30 cm | | | G = 40 cm | | | G = 50 cm | | |
| L | L | | D1 | L | | D2 | L | | D2 | L | | D2 | L | | D2 | L |
| (closed) | (rolled) | N | [cm] | [cm] | N | [cm] | [cm] | N | [cm] | [cm] | N | [cm] | [cm] | N | [cm] | [cm] |
| 100 | 136 | 4.87 | 13.31 | 136.36 | 1.98 | 11.46 | 136.36 | 1.55 | 10.82 | 136.36 | 1.27 | 10.41 | 136.36 | 1.07 | 10.11 | 136.36 |
| 125 | 170 | 5.70 | 14.55 | 170.45 | 2.43 | 12.15 | 170.45 | 1.92 | 11.38 | 170.45 | 1.58 | 10.87 | 170.45 | 1.34 | 10.51 | 170.45 |
| 150 | 205 | 6.45 | 15.68 | 204.55 | 2.88 | 12.81 | 204.55 | 2.28 | 11.92 | 204.55 | 1.88 | 11.32 | 204.55 | 1.60 | 10.89 | 204.55 |
| 175 | 239 | 7.16 | 16.73 | 238.64 | 3.31 | 13.46 | 238.64 | 2.64 | 12.45 | 238.64 | 2.18 | 11.77 | 238.64 | 1.85 | 11.28 | 238.64 |
| 200 | 273 | 7.81 | 17.72 | 272.73 | 3.73 | 14.09 | 272.73 | 2.98 | 12.98 | 272.73 | 2.48 | 12.21 | 272.73 | 2.11 | 11.66 | 272.73 |
| 225 | 307 | 8.44 | 18.65 | 306.82 | 4.14 | 14.71 | 306.82 | 3.33 | 13.49 | 306.82 | 2.77 | 12.65 | 306.82 | 2.36 | 12.04 | 306.82 |
| 250 | 341 | 9.03 | 19.54 | 340.91 | 4.54 | 15.31 | 340.91 | 3.67 | 14.00 | 340.91 | 3.06 | 13.08 | 340.91 | 2.61 | 12.42 | 340.91 |
| 275 | 375 | 9.59 | 20.39 | 375.00 | 4.94 | 15.90 | 375.00 | 4.00 | 14.50 | 375.00 | 3.34 | 13.51 | 375.00 | 2.86 | 12.79 | 375.00 |
| 300 | 409 | 10.13 | 21.20 | 409.09 | 5.32 | 16.48 | 409.09 | 4.33 | 14.99 | 409.09 | 3.62 | 13.94 | 409.09 | 3.11 | 13.16 | 409.09 |
| 325 | 443 | 10.65 | 21.98 | 443.18 | 5.70 | 17.05 | 443.18 | 4.65 | 15.48 | 443.18 | 3.90 | 14.35 | 443.18 | 3.35 | 13.53 | 443.18 |
| 350 | 477 | 11.16 | 22.73 | 477.27 | 6.07 | 17.60 | 477.27 | 4.97 | 15.95 | 477.27 | 4.18 | 14.77 | 477.27 | 3.59 | 13.89 | 477.27 |
| 375 | 511 | 11.64 | 23.46 | 511.36 | 6.43 | 18.15 | 511.36 | 5.28 | 16.42 | 511.36 | 4.45 | 15.18 | 511.36 | 3.83 | 14.25 | 511.36 |
| 400 | 545 | 12.11 | 24.17 | 545.45 | 6.79 | 18.68 | 545.45 | 5.59 | 16.89 | 545.45 | 4.72 | 15.59 | 545.45 | 4.07 | 14.61 | 545.45 |
| 425 | 580 | 12.57 | 24.85 | 579.55 | 7.14 | 19.21 | 579.55 | 5.90 | 17.35 | 579.55 | 4.99 | 15.99 | 579.55 | 4.31 | 14.96 | 579.55 |
| 450 | 614 | 13.01 | 25.52 | 613.64 | 7.48 | 19.73 | 613.64 | 6.20 | 17.80 | 613.64 | 5.26 | 16.39 | 613.64 | 4.54 | 15.32 | 613.64 |

Each row in Table 1, shows the number of turns N, the diameter of a rolled shaft D₁ or D₂, and the actual length of the curtain L for a given curtain length. Column 1 shows the closed length, which is also the height of the opening (e.g., door or window). Column 2 shows the length of an open curtain, which is also the length of the rolled curtain.

Columns 3-5 show the calculated parameters for a roller shutter with one shaft, while columns 6-17 show the same parameters for a roller shutter with two shafts, in accordance with some embodiments. The table shows the calculated parameters for different G values, between 20 cm to 50 cm.

As may be appreciated, for any curtain length, the number of turns and consequently the diameter of a rolled shaft in a roller shutter with two shafts is smaller than in a 1-shaft roller shutter. Moreover, those two parameters further decrease as G increases.

As may be apparent to the skilled in the art, the diameter of a rolled shaft may affect the depth of the box required for that roller shutter. For example, for a curtain length of 250 cm (when closed), the diameter D₁ of a 1-shaft roller shutter is 19.54 cm, while for the same curtain, the diameter D₂ of a roller shutter system with two shafts and with G=30 cm is 14 cm. A reduction of 5.5 cm of the roller shutter box depth is achieved.

The possible advantages of multiple-shaft roller shutters will be further explained.

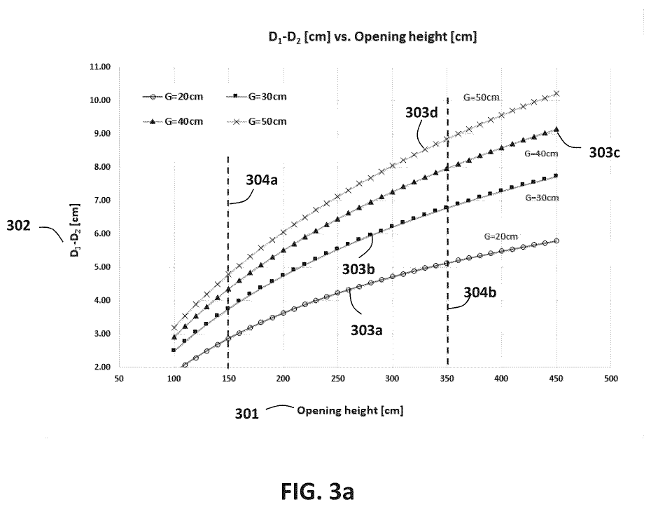

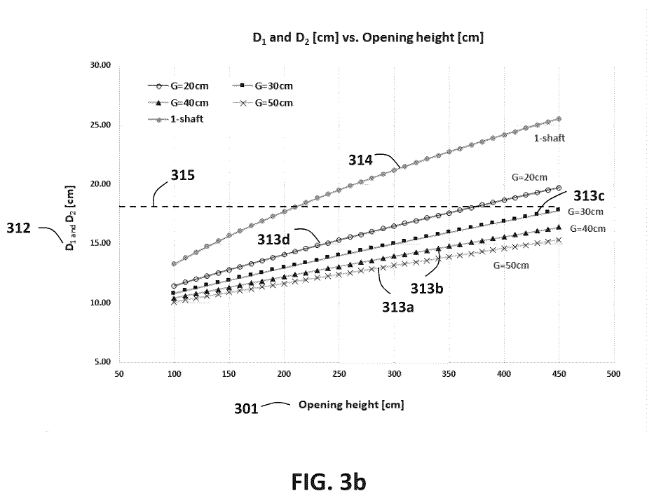

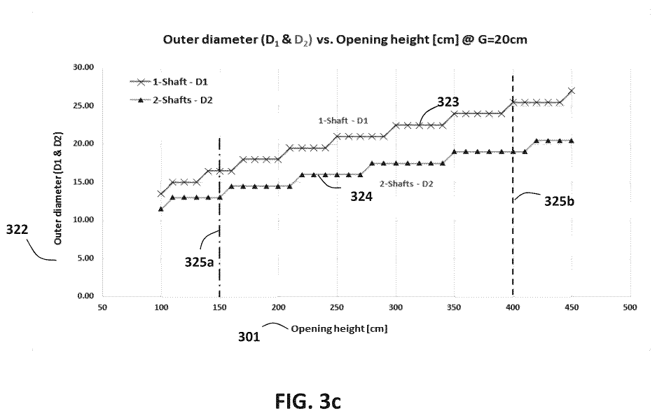

FIG. 3a is a graph illustrating the possible roller shutter box depth reduction in accordance with some embodiments of multiple-shaft roller shutter systems.

According to some embodiments, the possible reduction of the roller shutter box depth may be calculated by comparing the outer diameter D₁ 208 of a rolled simplified curtain 202 on the shaft 201 in a 1-shaft roller shutter system, to the outer diameter D₂ of a rolled simplified curtain 202 on the top shaft 102 and the bottom shaft 103 in a roller shutter system 220 with two shafts.

The data series in FIG. 3a show the possible depth reduction 302 for different gaps G between the center of the top shaft 102 and the center of the bottom shaft 103, and for an opening height 301, or, in other words, different lengths L of the simplified curtain 202 when the curtain is closed. As may be apparent to the skilled in the art, multiple-shaft roller shutter systems may comprise more than two shafts. Additional shafts between the top shaft 102 and the bottom shaft 103 may not provide any advantage with respect to the reduction of the box depth.

Data series 303a, 303b, 303c and 303d have common axes. The x-axis denotes the length of the rolled simplified curtain 202 (i.e., typically this will be the curtain length to be rolled). According to some embodiments, the curtain length is directly proportional to the height of the door, window, opening height, or aperture to be covered by the roller shutter. According to some embodiments, data series 303a, 303b, 303c and 303d are shown for opening heights between 100 cm and 450 cm. All the data series 303a, 303b, 303c and 303d were calculated using the assumptions and parameters as were used to calculate Table 1 above. This includes a rolled curtain length calculated from the opening height or closed roller shutter length.

The y-axis denotes the difference in cm between D₁ 208 and D₂ 228 as previously explained. Each of the data series 303a, 303b, 303c and 303d represents the difference D₁-D₂ 302 for a different vertical gap G between the center of the top shaft 102 and the center of the bottom shaft 103 for a multiple-shaft roller shutter system. For example, data series 303a was calculated for a vertical gap G=20 cm, data series 303b was calculated for a vertical gap G=30 cm, data series 303c was calculated for a vertical gap G=40 cm, and data series 303d was calculated for a vertical gap G=50 cm. As stated, data series 303a, 303b, 303c and 303d were calculated for a slat thickness of 7 mm. As may be apparent to the skilled in the art, many types of slats are commercially available, each with a specific thickness and construction. According to some embodiments, the vertical gap G 223 between the top shaft 102 and the bottom shaft 103 is selected to let the first turn of the rolled curtain be well adhered (i.e., small air gap) to the shafts.

As can be seen in FIG. 3a, according to some embodiments, for any gap size, the possible box depth reduction (D₁-D₂) increases as the curtain length increases. In addition, for any curtain length, the possible box depth reduction (D₁-D₂) may increase as the vertical gap G increases. For example, for a 150 cm long curtain (see left dotted line 304a), the possible box depth reduction may be close to 3 cm for G=20 cm and around 5 cm for G=50 cm. The reason for this relatively small increase is the small number of turns due to the short curtain length. For a 350 cm long curtain (see right dotted line 304b), the possible box depth reduction is more than 5 cm for G=20 cm and close to 9 cm for G=50 cm.

As may be apparent to the skilled in the art, according to some embodiments, the required depth of the roller shutter box can be reduced by altering the gap between the shafts in accordance with the curtain length and other parameters.

An alternative way to illustrate the possible roller shutter box depth reduction in accordance with some embodiments of a multiple-shaft roller shutter system is depicted in FIG. 3b.

FIG. 3b shows the diameter 312 D₁ or D₂ of a rolled shaft versus the opening height 301. The upper data series 314 shows the D₁ diameter of a 1-shaft roller shutter, while data series 313a, 313b, 313c and 313d show the diameter D₂ for different G values.

As can be seen, for any opening height 301, the size of D₁ is always larger than D₂. This difference can be expressed differently. Looking at the horizontal dotted line 315, a rolled 1-shaft diameter of 18 cm 314 (typical size for 20 cm walls) will suffice for openings not taller than 2m, while with a roller shutter system with two shafts and at G=20 cm, the same roller shutter box will hold curtains for openings of up to 3.5m.

FIG. 3c shows data series illustrating another aspect of the possible roller shutter box depth reduction in accordance with some embodiments. The x-axis denotes the opening height 301. Data series 323-324 are shown for opening heights between 100 cm and 400 cm.

The y-axis denotes the outer diameter in cm of D₁ 208 for a roller shutter system with one shaft or D₂ 228 for a roller shutter system with two shafts.

The upper data series 323 shows the value of D₁ 208 for different opening heights, while the data series 324 shows the value of D₂ 228 for different opening heights, both data series in accordance with some embodiments. In the data series 324 of the roller shutter system with two shafts, the vertical gap G 223 between the center of the top shaft 102 and the center of the bottom shaft 103 is 20 cm.

As may be appreciated in FIG. 3c, the data series 323-324 have a staircase shape. The reason for this staircase shape is the fact that once a rolled curtain of a certain length requires an additional turn on the shaft, the outer diameter will remain unchanged unless a new turn is required for a longer curtain. This staircase shape is not shown in the previous graphs.

According to some embodiments, this behavior of the outer diameter D₂ 228 may be used when designing the roller box in a roller shutter system.

With further reference to FIG. 3c, the graph shows how the difference between the outer diameter in cm of D₁ 208 for a 1-shaft roller shutter system and the outer diameter D₂ 228 for a roller shutter system 220 with two shafts versus the opening height 301. The outer diameter D₁ 208 and the outer diameter D₂ 228 increase as the length of the rolled simplified curtain 202 increases. For example, and according to some embodiments, for an opening height of 150 cm (left vertical line 325a), the difference 322 between D₂ and D₁ is approximately 3.5 cm, while for an opening height of 400 cm (right vertical line 325b), the difference 322 between D₂ and D₁ is approximately 6.5 cm. This 6.5 cm difference in the box depth may be very significant in the deployment of some roller shutter systems.

According to some embodiments, roller shutter system manufacturers may recommend vertical gap G 223 sizes in accordance with one or more of the following:
Opening height
Slat type
Side panel type
Wall thickness
Roller shutter box dimensions
Roller shutter box installation
Number of shafts
Coupling mechanism

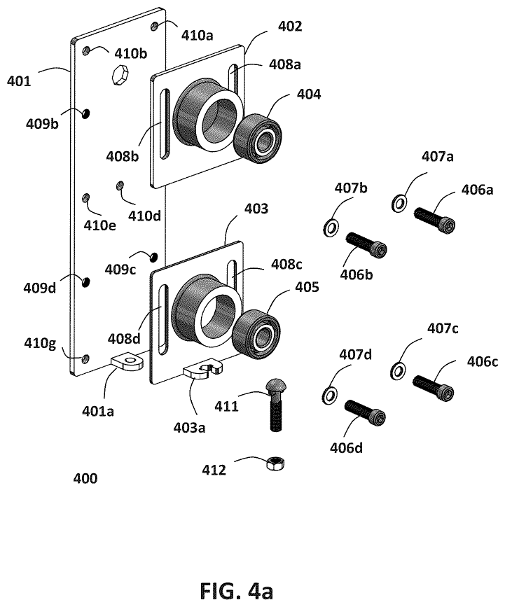

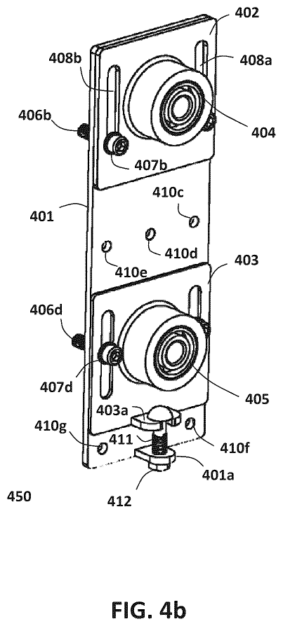

FIG. 4a shows an exploded view of a left side panel assembly 400, including a height-alignment of two shafts that may be used to implement certain aspects of the disclosed embodiments.

According to some embodiments, a left side panel assembly 400 is used to hold the top shaft 102 and the bottom shaft 103, horizontally aligned to the opening (e.g., to the floor of the door; or the bottom of the opening), parallel to each other, and/or with a given vertical gap G 223 therebetween. The side panel may also enable a vertical gap G 223 between the shafts, to keep the required tension of the chain 106 or belt linking between the two shafts.

According to some embodiments, at least one shaft further comprises bearings, and wherein the coupling mechanism in the at least one shaft may be attached to the bearings.

According to some embodiments, the left side panel assembly 400 may comprise a left side panel plate 401 which may be used to hold the left side panel top bearing housing 402 and left side panel bottom bearing housing 403 and which may be attached to the roller shutter box (not shown) through left side panel plate holes 410a, 410b, 410c, 410d, 410e, 410f, 410g (a few holes are hidden in the exploded view). According to some embodiments, the left side panel top bearing housing 402 may hold the left side panel top bearing 404 of the top shaft 102. The left side panel top bearing housing 402 may be attached to the left side panel plate 401 with left side panel clamping screws 406a, 406b, and left side panel upper washers 407a, 407b. A left side panel plate threaded hole (not shown) located on the upper-right corner of the left side panel plate 401 and a left side panel plate threaded hole 409b located on the upper-left corner of the left side panel plate 401 may be used to fasten the left side panel clamping screws 406a, 406b and hold the left side panel top bearing housing 402 firmly attached to the left side panel plate 401. When fastening the left side panel clamping screws 406a, 406b, the left side panel top bearing housing 402 can be moved up and down, using the left side panel top bearing housing holes 408a, 408b. This movement may be used to align the top shaft 102 to be fully parallel to the horizontal bottom of to the opening (e.g., the floor of the opening). As may be understood by the skilled in the art, this type of alignment may be done on one side of the roller shutter.

Similarly, the left side panel bottom bearing housing 403 may be attached to the left side panel plate 401 with left side panel clamping screws 406c, 406d, and left side panel lower washers 407c, 407d.

The left side panel plate threaded holes 409c, 409d may be used to fasten the left side panel clamping screws 406c, 406d, and hold the left side panel bottom shaft bearing 405 firmly attached to the left side panel plate 401. Also, the left side panel bottom bearing housing 403 can be aligned up and down, using the left side panel bottom bearing housing holes 408c, 408d, the same as in the left side panel top bearing housing 402. In some embodiments, the up-down alignment may be used to achieve the desired vertical gap G 223 and to align the bottom shaft 103 to be parallel to the top shaft 102. The range of movement of the bottom bearing housings on both sides of the shaft may be limited. In some embodiments, the size of the side plates may be adapted to the desired vertical gap G 223. In some embodiments, the vertical gap G 223 between the adjacent shafts is variable, and the length of the vertical gap is selected, at least, in accordance with the depth of the roller shutter box. In other cases, the vertical gap G 223 is in accordance with an alignment of at least a first turn of the curtain 1003 with a contour of the parallel shafts. In some embodiments, the vertical gap G 223 between the shafts is selected to yield complete turns of the curtain 1003 when the roller shutter curtain is fully rolled around the plurality of shafts.

In addition, the left side panel assembly 400 comprises a chain tension mechanism including a left side panel plate bracket 401a and the left side panel bottom bearing housing bracket 403a, a left side panel chain tension screw 411, and a left side panel nut 412. This mechanism is used to adjust the chain 106 or belt to the desired tension by closing or releasing the left side panel chain tension screw 411, e.g. by screw actuation of tension screw 411. In some embodiments, the roller shutter may comprise a plurality of chains 106, for example, on both sides and the center of the shaft.

FIG. 4b shows an assembled left side panel 450 including a height-alignment of two shafts that may be used to implement certain aspects of the disclosed embodiments. The left side panel chain tension mechanism, including left side panel plate bracket 401a, left side panel bottom bearing housing bracket 403a, a left side panel chain tension screw 411, and a left side panel nut 412, can be seen as fully assembled.

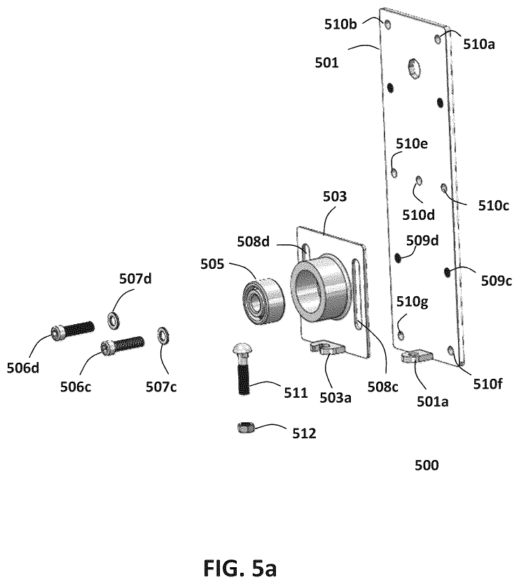

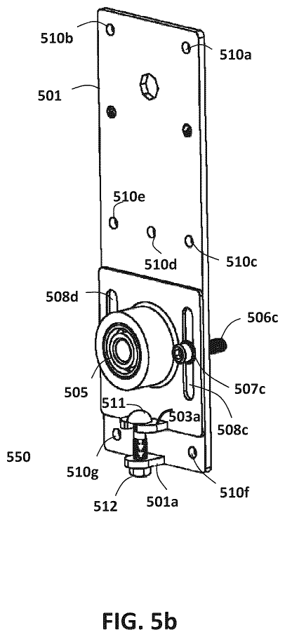

FIG. 5a shows an exploded view of a right-side panel assembly 500 including a height-alignment of the bottom shaft only, that may be used to implement certain aspects of the disclosed embodiments.

According to some embodiments, a right-side panel assembly 500 is used to hold the top shaft 102 and the bottom shaft 103. The right-side panel assembly may also be used to adjust the vertical gap G 223 between the shafts, to keep the required tension of the chain 106 or belt linking between the shafts.

According to some embodiments, the right-side panel assembly 500 may comprise a right-side panel plate 501, which may be used to hold the right-side panel bottom bearing housing 503 and which may be attached to the roller shutter box (not shown) through right-side panel plate holes 510a, 510b, 510c, 510d, 510e, 510f, 510g.

The right-side panel bottom bearing housing 503 can be attached to the right-side panel plate 501 using the right-side panel plate left threaded holes 509c, 509d, the right-side panel clamping screws 506c, 506d, and the right-side panel lower washers 507c, 507d, and may hold the right-side panel bottom shaft bearing 505. Also, the right-side panel bottom bearing housing 503 can be aligned up and down, using right-side panel bottom bearing housing holes 508c, 508d. The up-down alignment may be used to achieve a vertical gap G 223 and to align the bottom shaft 103 to be parallel to the top shaft 102. In some embodiments, the size of the side plates may be adapted to the desired vertical gap G 223. In some embodiments, the vertical gap G 223 between the top shaft 102 and the bottom shaft 103 is variable, and the length of the vertical gap is selected, at least, in accordance with the depth of the roller shutter box. In other cases, the vertical gap G 223 is in accordance with an alignment of at least a first turn of the curtain 1003 with a contour of the parallel shafts. In some embodiments, the vertical gap G 223 between the top shaft 102 and the bottom shaft 103 is selected to yield complete turns of the curtain 1003 when the roller shutter curtain is fully rolled around the plurality of shafts 102-103.

In addition, the right-side panel bottom bearing housing 503 may comprise a right-side panel chain tension mechanism including the right-side panel plate bracket 501a, a right-side panel bottom bearing housing bracket 503a, a right-side panel chain tension screw 511, and a right-side panel nut 512. This mechanism is used to adjust the chain 106 or belt to the desired tension by closing or releasing the right-side panel chain tension screw 511. In some embodiments, the roller shutter may comprise a plurality of chains 106, for example, on both sides and the center of the shaft.

FIG. 5b shows a view of an assembled right-side panel 550, including a height-alignment of two shafts, that may be used to implement certain aspects of the disclosed embodiments. The right-side panel chain tension mechanism, including right-side panel plate bracket 501a, right-side panel bottom bearing housing bracket 503a, a right-side panel chain tension screw 511, and a right-side panel nut 512, can be seen as fully assembled. According to some embodiments, the chain 106 tension may be adjusted in parallel on the left and right-side panels.

According to some embodiments, the left side panel described in FIG. 4b may be installed on the right side of the roller shutter system, while the right side panel described in FIG. 5b may be installed on the left side of the roller shutter system.

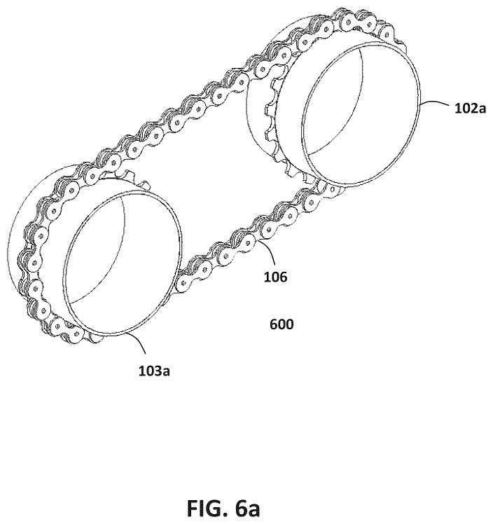

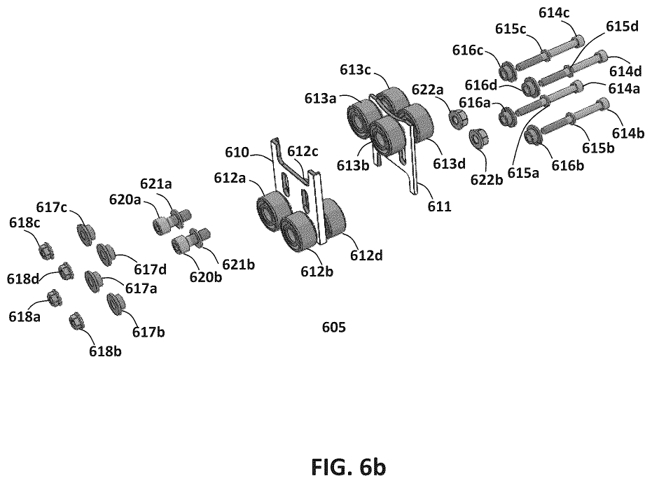

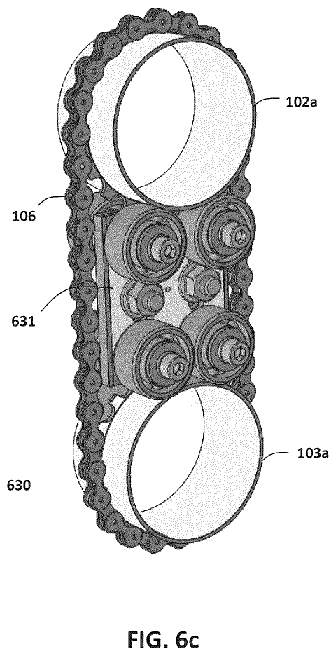

FIG. 6a shows an perspective view of a coupling mechanism 600 comprising two sprocket wheels and a chain, wherein the sprocket wheels are mounted on a top shaft-hub 102a and a bottom shaft-hub 103a that may be used to implement certain aspects of the disclosed embodiments.

According to some embodiments, the top shaft 102 may comprise at least one shaft-hub, and the bottom shaft 103 may comprise at least one shaft-hub, wherein the top shaft-hub 102a and the bottom shaft-hub 103a may each comprise a sprocket wheel. The transmission of rotation from the top shaft-hub 102a located on the top shaft 102 to the bottom shaft-hub 103a located on the bottom shaft 103 may be performed by a chain 106, which is geared to the sprocket wheels. According to some embodiments, the tension of the chain 106 may be adjusted by a left side panel chain tension screw 411 and a right-side panel chain tension screw 511.

According to some embodiments, using a shaft-hub may facilitate the installation of the roller shutter system, allowing the positioning of the coupling mechanism to be defined during the installation phase.

In some embodiments, the cross-section of the top shaft-hub 102a and the bottom shaft-hub 103a may be matched to the cross-section of the shaft (e.g., circular, octagonal, otherwise polygonal, etc.). According to some embodiments, the top shaft-hub 102a and the bottom shaft-hub 103a may be secured to the respective shafts with screws (not shown) or any other suitable method.

FIG. 6b shows an exploded view of an unassembled floating chain-tension device 605 comprising two floating chain-tension device plates, eight floating chain-tension device bearings, and additional hardware that may be used to implement certain aspects of the disclosed embodiments.

According to some embodiments, a floating chain-tension device may be used to keep the required tension of a chain or belt (e.g., a chain or belt in the center of the shaft). According to some embodiments, the floating chain-tension device is located between the shafts on both sides of a chain or belt. See, for example, FIG. 6c and FIG. 10d.

According to some embodiments, a floating chain-tension device may comprise a base plate 610 and a slider plate 611. Four upper chain-tension bearings 612a, 612b, 612c, 612d (i.e., 612c is partly shown), may be attached to the base plate 610.

According to some embodiments, the floating chain-tension device is located between the top shaft 102 and bottom shaft 103 and between both sides of a chain 106 or belt wherein the upper chain-tension bearings 612a, 612b, 612c, 612d are in contact and press the top shaft 102, and the lower chain-tension bearings 613a, 613b, 613c, 613d are in contact and press the bottom shaft 103.

According to some embodiments, the chain-tension bearings can freely rotate when the top shaft 102 and the bottom shaft 103 rotate, thus avoiding friction between the chain-tension bearings and the shafts. According to some embodiments, the chain-tension bearings may be coated with an elastomeric layer (e.g., polyurethane, thermoplastic elastomer, or silicone). The layer may provide elasticity and vibration damping.

According to some embodiments, the upper chain-tension bearings 612a, 612b, 612c (not shown) and 612d and the lower chain-tension bearings 613a, 613b, 613c, 613d are respectively attached to the base plate 610 and slider plate 611 by a set of tension-chain device screws 614a, 614b, 614c, 614d, tension-chain device screw washers 615a, 615b, 615c, 615d, tension-chain device bearing washers 616a, 616b, 616c, 616d, 617a, 617b, 617c, 617d and tension-chain device screw nuts 618a, 618b, 618c, 618d.

According to some embodiments, the base plate 610 and slider plate 611 are attached to one another using tension-chain device holding screws 620a, 620b, tension-chain device plate washers 621a, 621b, and tension-chain device plate nuts 622a, 622b.

The elongated or oval-shaped holes in the base plate 610 and slider plate 611 may be used to adjust the distance between the upper chain-tension bearings 612a, 612d in the base plate 610 and the lower chain-tension bearings 613a, 613d in the slider plate 611, thus achieving the required tension of the belt or chain.

In some embodiments, the floating chain-tension device may comprise springs (e.g., compression springs; not illustrated) to maintain the required pressure on the top shaft 102 and bottom shaft 103. In some embodiments, rotating a screw may be used to increase or reduce the distance between the chain-tension bearings on both plates.

FIG. 6c shows a complete assembly 630 of a floating chain-tension device 631 inserted between a top shaft 102 and a bottom shaft 103.

As may be seen in FIG. 6c, the floating chain-tension device 631 is not fixed-attached to any other element of the roller shutter system. The design of the floating chain-tension device 631, including the placement of the chain-tension bearings on the base plate 610 and slider plate 611, prevents movement of the floating chain-tension device 631 along the shafts or out of the shafts.

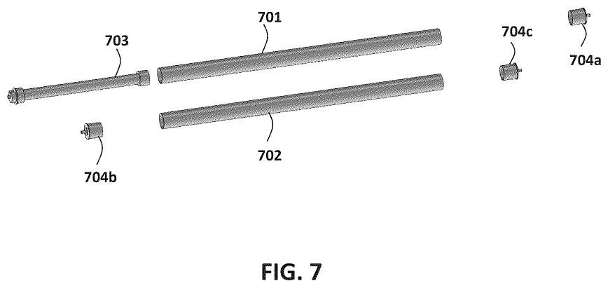

FIG. 7 shows an exploded view of the shafts of the roller shutter system that may be used to implement certain aspects of the disclosed embodiments. For clarity purposes, some additional elements (e.g., sprocket wheels) were not included in the exploded view.

According to some embodiments, the top shaft 102 may comprise a top shaft body 701, and a single end-pin 704a on one extreme of the shaft. According to some embodiments, the shaft of the roller shutter comprises an electrical motor 703 (i.e., curtain motor) or manual drive on one side of the shaft, and the rotation of the shaft may be driven by the electrical motor 703 or manual drive. In some embodiments, the electrical motor 703 or manual drive may be used to drive the rotation of the top shaft 102 directly; and the bottom shaft 103 through the coupling mechanism (e.g., chain or belt).

According to some embodiments, the bottom shaft 103 may comprise a bottom shaft body 702, a left end-pin 704b, and a right end-pin 704c on the sides of the bottom shaft body 702. In some embodiments, the top shaft 102 further comprises at least one sleeve inserted on the shaft, wherein the sleeve prevents bending of the roller shutter curtain slats lying on the shaft (see FIG. 10a).

According to some embodiments, each of the shafts may comprise at least one sleeve inserted on the shaft to prevent contact of the roller shutter curtain slats with the coupling mechanism (e.g., chain).

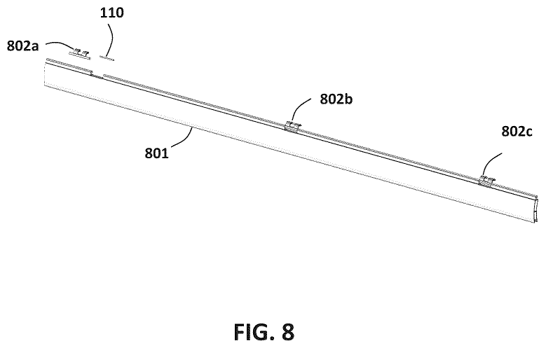

FIG. 8 shows an exploded view of the top slat 801 or curtain profile of the roller shutter that may be used to implement certain aspects of the disclosed embodiments. According to some embodiments, the top slat 801 of the roller shutter is the slat that may be used to attach the curtain to the coupling mechanism and let the curtain move up or down when the shafts rotate.

According to some embodiments, the top slat 801 may comprise a left side hanger 802a, a center hanger 802b, and a right-side hanger 802c that may be used to attach the top slat 801 to the coupling mechanism (e.g., chains or chain pins). The number of hangers and their position along the slat is in accordance with the number of chains and their position on the shafts. According to some embodiments, the left side hanger 802a, the center hanger 802b, and the right-side hanger 802c may be part of the top slat 801 itself and not separate elements as shown in FIG. 8.

According to some embodiments, the attachment of the left side hanger 802a, the center hanger 802b, and the right-side hanger 802c to the respective chains is performed with connection pins 110. According to some embodiments, a chain pin connecting two links is used. According to some embodiments, normal chain pins may be replaced with longer connection pins 110, which, at the same time, attach the top slat 801 to the chain. As may be apparent to the skilled in the art, the top slat 801 may be linked to the coupling mechanism in many other different ways.

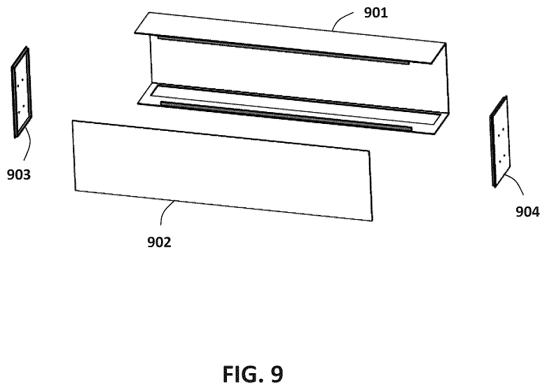

FIG. 9 shows an exploded view of an exemplary roller shutter box that may be used to implement certain aspects of the disclosed embodiments.

According to some embodiments, the roller shutter box may be installed above the opening (e.g., door or window) to hold the shafts of the roller shutter and the rolled curtain.

According to some embodiments, the roller shutter box is operational to hold a roller shutter curtain rolled along a curved outline shell surface, the curved outline shell surface bounded by outer limits of the plurality of shafts and the rolled curtain.

According to some embodiments, the roller shutter box comprises a box back 901, a box front panel 902, a box left side panel 903, and a box right-side panel 904. The box back 901 dimensions are adapted to the roller shutter dimensions when the curtain is fully rolled on the shafts. The depth of the box back 901 is greater than the size of the outer diameter D₂ 228 to let the shaft rotate even when the curtain is fully rolled. Similarly, and according to some embodiments, the height of the box may be greater than the total height TH 226 of the roller shutter assembly. The curtain moves up and down through a rectangular hole in the bottom of the box. According to some embodiments, the side panel plates may be respectively attached with screws to the box left side panel 903 and to the box right-side panel 904.

According to some embodiments, the roller shutter box comprises a box front panel 902, which may be used to close the box back 901. When required, the box front panel 902 may be removed to provide access to the shafts and additional roller shutter elements, for example, for maintenance purposes. According to some embodiments, the box back 901 and the box front panel 902 may comprise a noise reduction coating.

FIG. 10a illustrates an exemplary fully rolled roller shutter assembly 1000 that may be used to implement certain aspects of the disclosed embodiments.

According to some embodiments, the roller shutter comprises a box back 901 which holds the shafts and the rolled curtain. Side panels (in FIG. 10a, only the right-side panel plate 501 is shown) may be used to hold the shafts. The roller shutter box may be closed with a box front panel 902 (shown in phantom). According to some embodiments, the curtain 1003 moves up and down along the opening through a left guide rail 1001 and a right guide rail 1002 on both sides of the opening.

FIG. 10b illustrates another view of an exemplary assembly of an unrolled roller shutter assembly 1050 that may be used to implement certain aspects of the disclosed embodiments. In FIG. 10b, the curtain 1003 is fully closed, and the front cover is shown in phantom, allowing one to see the elements inside the roller shutter box.

The roller shutter may comprise a box back 901 with a box front panel 902. According to some embodiments, inside the box back 901, the top shaft 102 and the bottom shaft 103 are installed with a left side chain 106a, a center chain 106b, and a right-side chain 106c linking between the shafts. The top shaft 102 and bottom shaft 103 are held by side panel plates. Alignment of the shafts may be performed by moving the left side panel top bearing housing 402 and the left side panel bottom bearing housing 403 up and down. The bearing housing on the right-side is not shown. Same as in FIG. 10a, the curtain 1003 moves up and down along the opening through a left guide rail 1001 and a right guide rail 1002 on both sides of the opening. As may be seen in FIG. 10b, the curtain passes between the box back 901 and the opening through a rectangular hole on the bottom of the box back 901.

FIG. 10c illustrates another view of an exemplary assembly of a sleeve-protected roller shutter assembly 1070 that may be used to implement certain aspects of the disclosed embodiments. In FIG. 10c, the curtain 1003 is fully closed, and the front cover is shown in phantom, allowing one to see the elements inside the roller shutter box.

According to some embodiments, the top shaft comprises sleeves 1010a, 1010b, 1010c and 1010d and the bottom shaft comprises sleeves 1011a, 1011b, 1011c and 1011d. According to some embodiments, the number of sleeves on each shaft is in accordance with the number of chains. According to some embodiments, the gap provided by the sleeves, between the surface of the slats and chain links, is in accordance with at least one of a slat material, length of the slats, distance between the chains, number of turns when the roller shutter curtain is fully rolled, and type of the chains.

FIG. 10d illustrates a view of a reinforced roller shutter assembly 1090 that may be used to implement certain aspects of the disclosed embodiments. In FIG. 10d, the curtain 1003 is fully closed, and the front cover is shown in phantom, allowing one to see the elements inside the roller shutter box.

According to some embodiments, the reinforced roller shutter assembly 1090 comprises a top shaft, a bottom shaft, and a left side chain 106a, a center chain 106b, and a right-side chain 106c. A floating chain-tension device is located in the center of the shafts to keep the tension of the center chain 106b as required.

The present disclosure may be described, merely for clarity, in terms of terminology specific to some embodiments or individual products of the roller shutter system, and its components. It will be appreciated that this terminology is intended to convey general principles of operation clearly and briefly, by way of example, and is not intended to limit the scope of the invention to any particular roller shutter system and/or any of its components.

Elements separately listed herein need not be distinct components and alternatively may be the same structure. A statement that an element or feature may exist is intended to include (a) embodiments in which the element or feature exists; (b) embodiments in which the element or feature does not exist; and (c) embodiments in which the element or feature exist selectively (e.g., a user may select whether the element or feature does or does not exist).

All examples and conditional language recited herein are intended for pedagogical purposes to aid the reader in understanding the described principles and the concepts contributed by the inventor to further the art and are to be construed as being without limitation to such specifically recited examples and conditions. Moreover, all statements herein reciting the described principles, aspects, and embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

1. A roller shutter system, comprising:
a. a roller shutter box and,
b. a roller shutter curtain comprising a plurality of slats and,
c. a plurality of shafts, parallel each other, wherein the plurality of shafts is horizontally installed in the roller shutter box, wherein the roller shutter box is located on an upper part of the roller shutter system, and used to hold the rolled shutter curtain; wherein at least one shaft from the plurality is operational to rotate around its axis-of-rotation and, wherein adjacent shafts of the plurality of shafts are separated by a vertical gap;
and wherein the roller shutter curtain is rolled along a curved outline shell surface, the curved outline shell surface bounded by outer limits of the plurality of shafts and rolled curtain.

2. The roller shutter system of claim 1, wherein a shaft of the plurality of shafts rotates around its axis-of-rotation, and wherein rotation causes the roller shutter curtain to roll along the curved outline shell surface.

3. The roller shutter system of claim 2, the roller shutter system further comprising a coupling mechanism wherein a first shaft and a second shaft of the plurality of shafts are coupled by the coupling mechanism, and wherein the rotation of the first shaft causes the second shaft to rotate in same direction using the coupling mechanism.

4. The roller shutter system of claim 2, the roller shutter system further comprising a coupling mechanism, wherein a first shaft and a second shaft of the plurality of shafts are coupled by the coupling mechanism, wherein the first shaft and second shaft have an axis-of-rotation, wherein the second shaft further comprises at least one element operational to rotate around the axis-of-rotation of the second shaft, and wherein the rotation of the first shaft causes the at least one element in the second shaft to rotate in a same direction, using the coupling mechanism.

5. The roller shutter system of claim 3, wherein the coupling mechanism comprises at least one of a chain, a belt, a gear, and a cable, wherein the roller shutter curtain is attached to the coupling mechanism, and wherein the rotation of the first shaft causes the roller shutter curtain to roll along the curved outline shell surface.

6. The roller shutter system of claim 5, wherein the first shaft is a top shaft and the second shaft is a bottom shaft and wherein the bottom shaft further comprises bearings and wherein the coupling mechanism in the bottom shaft is attached to the bearings.

7. The roller shutter system of claim 2, the roller shutter system further comprising an electrical motor, wherein the rotation of a shaft is driven by the electrical motor.

8. The roller shutter system of claim 1, the roller shutter system further comprising one or more side plates configured to hold or mount the plurality of shafts.

9. A method to reduce a roller shutter box depth in a roller shutter system, wherein the roller shutter system comprises a roller shutter box; a roller shutter curtain comprising a plurality of slats; and a plurality of shafts parallel each other, wherein the plurality of shafts is horizontally installed in the roller shutter box, wherein the roller shutter box is located on an upper part of the roller shutter system and operational to hold the roller shutter curtain when rolled around the plurality of shafts; at least one shaft from the plurality of shafts is operational to rotate around its axis-of-rotation; and adjacent shafts of the plurality of shafts are separated by a vertical gap, the method comprising:
rolling the roller shutter curtain along a curved outline shell surface, the curved outline shell surface bounded by outer limits of the plurality of shafts and the roller shutter curtain.

10. The method of claim 9, wherein a shaft of the plurality of shafts rotates around its axis-of-rotation, and wherein rotation causes the roller shutter curtain to roll along the curved outline shell surface.

11. The method of claim 10, the roller shutter system further comprising a coupling mechanism wherein a first shaft and a second shaft of the plurality of shafts are coupled by the coupling mechanism, and wherein the rotation of the first shaft causes the second shaft to rotate in same direction using the coupling mechanism.

12. The method of claim 10, the roller shutter system further comprising a coupling mechanism, wherein a first shaft and a second shaft of the plurality of shafts are coupled by the coupling mechanism, wherein the first shaft and second shaft have an axis-of-rotation, wherein the second shaft further comprises at least one element operational to rotate around the axis-of-rotation of the second shaft, and wherein the rotation of the first shaft causes the at least one element in the second shaft to rotate in a same direction, using the coupling mechanism.

13. The method of claim 11, wherein the coupling mechanism comprises at least one of a chain, a belt, a gear, and a cable, wherein the roller shutter curtain is attached to the coupling mechanism, and wherein the rotation of the first shaft causes the roller shutter curtain to roll along the curved outline shell surface.

14. The method of claim 10, wherein the vertical gap between the adjacent shafts is variable, and wherein length of the vertical gap is selected, at least, in accordance with a depth of the roller shutter box.

15. The method of claim 10, wherein the vertical gap between the adjacent shafts is variable, and wherein length of the vertical gap is in accordance with an alignment of at least a first turn of the roller shutter curtain with a contour of the plurality of shafts.

16. The method of claim 13, wherein the first shaft is a top shaft, and the second shaft is a bottom shaft; the bottom shaft further comprises bearings; and the coupling mechanism in the bottom shaft is attached to the bearings.

17. The method of claim 13, wherein the first shaft is a top shaft, and the second shaft is a bottom shaft; and at least the top shaft further comprises at least one sleeve inserted on the top shaft, wherein the at least one sleeve prevents bending of the slats lying on the top shaft.

18. The method of claim 13, wherein each shaft of the plurality of shafts comprises at least one sleeve inserted on the shaft, wherein the at least one sleeve prevents contact of the slats with the coupling mechanism.

19. The method of claim 10, the roller shutter system further comprising an electrical motor and wherein the rotation of a shaft is driven by the electrical motor.

20. The method of claim 10, wherein the vertical gap is selected to yield complete turns of the roller shutter curtain when the roller shutter curtain is fully open.

21. A roller shutter assembly installed in a roller shutter box, wherein the roller shutter box is located on an upper part of a roller shutter system and used to hold a roller shutter curtain in the roller shutter system, the roller shutter assembly comprising a plurality of shafts, parallel each other, wherein the plurality of shafts is horizontally installed in the roller shutter box, wherein at least one shaft from the plurality is operational to rotate around its axis-of-rotation and, wherein adjacent shafts of the plurality of shafts are separated by a vertical gap; and wherein the roller shutter box is operational to hold the roller shutter curtain, wherein said roller shutter curtain is rolled along a curved outline shell surface, wherein the curved outline shell surface is bounded by outer limits of the plurality of shafts and the roller shutter curtain.

22. The roller shutter assembly of claim 21, wherein a shaft of the plurality of shafts rotates around its axis-of-rotation, and wherein rotation causes a roller shutter curtain attached to the roller shutter assembly to roll along the curved outline shell surface.

23. The roller shutter assembly of claim 22, wherein the roller shutter assembly further comprises a coupling mechanism, and wherein a first shaft and a second shaft of the plurality of shafts are coupled by the coupling mechanism, wherein the rotation of the first shaft causes the second shaft to rotate in same direction using the coupling mechanism.

24. The roller shutter assembly of claim 22, wherein the roller shutter assembly further comprises a coupling mechanism, and wherein a first shaft and a second shaft of the plurality of shafts are coupled by the coupling mechanism, wherein the first shaft and second shaft have an axis-of-rotation, wherein the second shaft further comprises at least one element operational to rotate around the axis-of-rotation of the second shaft, and wherein the rotation of the first shaft causes the at least one element in the second shaft to rotate in a same direction, using the coupling mechanism.

25. The roller shutter assembly of claim 23, wherein the coupling mechanism comprises at least one of a chain, a belt, a gear, and, a cable, and wherein the rotation of the first shaft causes a roller shutter curtain attached to the coupling mechanism to roll along the curved outline shell surface.

26. The roller shutter assembly of claim 22, wherein the roller shutter curtain comprises a plurality of slats, wherein a first shaft of the plurality of shafts is a top shaft, and a second shaft of the plurality of shafts is a bottom shaft; and the top shaft further comprises at least one sleeve inserted on the top shaft, wherein the at least one sleeve prevents bending of the slats lying on the top shaft.

27. The roller shutter assembly of claim 23, wherein the roller shutter curtain comprises a plurality of slats, wherein each shaft of the plurality of shafts comprises at least one sleeve inserted on the shaft, wherein the at least one sleeve prevents contact of the slats with the coupling mechanism.

28. The roller shutter assembly of claim 22, the roller shutter assembly further comprising an electrical motor, wherein the rotation of a shaft from the plurality is driven by the electrical motor.

29. The roller shutter assembly of claim 22, wherein the roller shutter assembly comprises two shafts.
